(19) United States
(12) Patent Application Publication
(10) Pub. No.: US 2017/0248736 A1
(43) Pub. Date: Aug. 31, 2017

(54) AUTOMATIC DATA EDITOR FOR WELL LOG DATA

(71) Applicant: Apache Corporation, Houston, TX (US)

(72) Inventor: Ryan Banas, Midland, TX (US)

(21) Appl. No.: 15/055,670

(22) Filed: Feb. 29, 2016

(51) Int. Cl. G01V 11/00; G01V 5/04; G01V 3/38

(52) U.S. Cl. CPC G01V 11/002; G01V 3/38; G01V 5/045

(57) ABSTRACT

A method for estimating values of well log measurements of a first selected type in wellbore sections wherein the measurements of the selected type are determined not to be valid includes establishing a linear relationship between measurements of a first selected type and measurements of a second selected type. The measurements of the second selected type are substantially valid over an entire measured axial section of the wellbore. Correct values of the measurements of the first type in the wellbore sections using measured values of the second type and the linear relationship.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not Applicable.

### BACKGROUND

This disclosure relates generally to the field of well logging. More particularly, the invention relates to estimating values of well log measurements that would have been made by a particular well logging instrument in the event certain portions of a well log are determined to have invalid or inaccurate values of such parameter.

Well logging is a process in which one or more sensors are moved along the interior of a wellbore drilled through subsurface formations. The one or more sensors measure one or more physical properties of the formations which may be interpreted to determine, e.g., mineral composition of the rock formations, their fractional volume of pore space (porosity) and fluid content of the pore space (i.e., water oil and/or gas).

Well logging instruments may be moved along the wellbore, for example, using armored electrical cable extended by a winch, by including them in a portion of a pipe string (logging while drilling—“LWD”), by slickline, coiled tubing, workover pipe or similar means.

Well log sensor measurements may be affected by a number of environmental factors, such as the type of fluid in the wellbore, the nominal diameter of the wellbore, whether the instrument is in the preferred position with respect to the wellbore at the time the measurements are made, and the rugosity of the wall of the wellbore. In certain cases, such when the wellbore is washed out, rugose or for some other reason enlarged to a sufficiently large diameter, measurements from certain of the well logging sensors may be inaccurate or invalid altogether. Using automated log analysis interpretation method run on a computer, interpreted values of, e.g., mineral content, porosity and fluid content may be invalid as well

What is needed is an automated technique to estimate correct values for well log measurements that may be invalid so that a reasonable interpreted well log may be made over more of the logged portion of the wellbore than may otherwise be possible.

### SUMMARY

A method according to one aspect for estimating values of well log measurements of a first selected type in wellbore sections wherein the measurements of the selected type are determined not to be valid includes establishing a linear relationship between well log measurements of a first selected type and well log measurements of a second selected type. The well log measurements of the second selected type are substantially valid over an entire measured axial section of the wellbore. Correct values of the well log measurements of the first type in the wellbore sections are determined using measured values of the second type and the linear relationship.

### BRIEF DESCRIPTION OF THE DRAWINGS

FIG. 1 is an example cross plot that may be used to identify invalid log measurements.

FIG. 2 shows an example zone where neutron and density flags have been computed from bad hole flags entered into the program.

FIGS. 3A and 3B, show, respectively, unzoned and zoned results according to an example selected zoning parameter.

FIG. 4 shows an example final result of using an example method according to the disclosure.

FIG. 5 shows an example computer system for performing methods according to the present disclosure.

### DETAILED DESCRIPTION

An example automatic well log editing program according to the present disclosure may use multiple well log measurement type linear regressions. The present example implementation has a systematic work flow that may automatically generate a number of linear regression sets based on zoning and flags to indicate areas or zones of unacceptable quality well log data. After the linear regressions have been generated, the method implements an algorithm to patch in corrected well log data with the best regression set available into the zones wherever the original well log measurements have been determined to be erroneous or of poor quality.

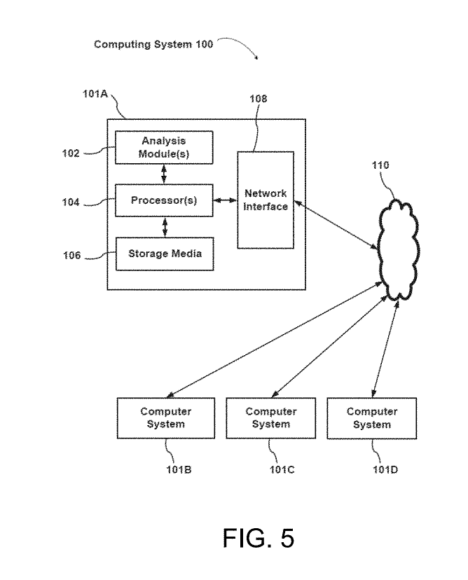

Well log measurements may be obtained by moving one or more well logging instruments along the interior of a wellbore drilled through subsurface formations. The wellbore may have pipe or casing disposed thereon, or may be uncased (“open hole”). The wellbore may be filed with fluids of various types such as drilling mud or completion fluid such as brine. As explained in the Background section herein, various means for conveying well logging instruments along the interior of the wellbore are known in the art and any of them are applicable to obtain well log measurements usable with methods according to the present disclosure. The well log measurements may be recorded by a recording device associated with a computer system (see FIG. 5).

An example of well log measurements that may be input to an editing procedure according to the present disclosure is shown in Table 1.

TABLE 1

| | | Minimum | Maximum |
|---|---|---|---|
| Input Measurement | Units | Value | Value |
| bulk density | kg/m³ or g/cm³ | 0.50 | 3.00 |
| neutron porosity | decimal fraction | −.15 | .60 |
| compressional sonic | μs/m or μs/ft | 45 | 200 |
| slowness | | | |
| photoelectric index | barns/e | 0 | 5 |
| gamma-ray | gamma-ray API units | 0 | 300 |
| resistivity | ohm-m | 0.02 | 2000 |
| neutron-density bad | dimensionless | none | none |
| hole flag | | | |
| Sonic-density bad hole | dimensionless | none | none |
| flag | | | |
| neutron-sonic bad hole | dimensionless | none | none |
| flag | | | |
| photoelectric index | dimensionless | none | none |
| bad hole flag | | | |

The user may specify the minimum and maximum values, or they may be predetermined for a particular geographic/geologic area or geodetic location. The measurements shown in Table 1 are not meant to be an exhaustive list of the types of well log measurements that may be used in a method according to the present disclosure. Other types of well log data are known in the art and may be used in a method according to the present disclosure as well. For purposes of the present example method, at minimum it is only necessary to have two different types of well log measurements. Preferably one of the types of measurements is less affected by wellbore conditions than the other, for example, deep reading electromagnetic induction derived resistivity may be one of the measurement types less affected by wellbore conditions, while bulk density well logs using wall contact sensors may be more affected by wellbore conditions. The user selects the type of well log measurements made in a particular well and causes the recording device to enter the well log data for those types of measurements into the computer system (see FIG. 5).

Example methods according to the present disclosure assume that a linear relationship exists between well log data measurements expressed as follows:

y=a+bx (1)

The variables a and b (offset and slope) may be computed, for example, using a least-squares minimization to reduce total error. An example implementation may be built from a set of such equations and may be solved with a basic linear algebra matrix inversion as shown below to yield a set of weighting coefficients.

Ax=b (2)

wherein A is a M×N matrix and b is a vector of size N.

A number of systems as shown above are generated where each A matrix consists of a combination of available well log measurements to solve for the well log measurement to be edited, in vector form as b, or the weight coefficients. A generalized system is shown below with the following variables defined: U is unity, j is the depth index, i is the index of the current regression set, N is the total size of the depth array, m is the total number of inputs in the current regression set, k is the index of the current input, and w is the resulting solution weight coefficient.

$$[ \begin{matrix}{U}_{1} & Σ {C}_{j , k , i} & Σ {C}_{j , k + 1 , i} & Σ {C}_{j , k = m , i} \\ {U}_{2} & Σ {C}_{j + 1 , k , i} & Σ {C}_{j + 1 , k + 1 , i} & Σ {C}_{j + 1 , k = m , i} \\ {U}_{3} & Σ {C}_{j + 2 , k , i} & Σ {C}_{j + 2 , k + 1 , i} & Σ {C}_{j + 2 , k = m , i} \\ {U}_{N} & Σ {C}_{j = N , k , i} & Σ {C}_{j = N , k + 1 , i} & Σ {C}_{j = N , k = m , i}\end{matrix} ] x = [ \begin{matrix}{W}_{0 , i} \\ {W}_{1 , i} \\ {W}_{2 , i} \\ {W}_{3 , i} \\ {W}_{N , i}\end{matrix} ] \qquad ( 3 )$$

The system may be solved using a subroutine, rmatrixsolvels, available from ALGIB Project, Poltavskaya street, 16, k.7, 603024 Nizhny Novgorod, Russian Federation. The foregoing subroutine is an from open source mathematics library and uses a singular value decomposition algorithm.

The present example method calculates only a certain number of the possible combinations illustrated in Eq. 4 based on a total possible m input curves supplied and k inputs selected for each system.

$$[ \frac{m !}{k ! ( m - k ) !} ] \qquad ( 4 )$$

The coefficients for the above solutions may then stored in an array and used to compute b from the following equation.

$${y}_{j , i} = {U}_{{W}_{0 , i}} + {C}_{j , k , i} {W}_{1 , i} + {C}_{j , k + 1 , i} {W}_{2 , i} + … + {C}_{j = N , k = m , i} {W}_{N , i} \qquad ( 5 )$$

The present example method may automatically choose the highest level solution available (with the greatest value of M) to use when generating data based on what data has been determined as erroneous or invalid data at each index j in the depth array. This is based on empirical observation and does not necessarily indicate that the largest matrix is the best mathematical solution in all instances.

It should be noted that the value of N is not necessarily the size of the original depth array. The present example implementation removes all indicated erroneous or invalid data from the regression and therefore only includes points where all M inputs are indicated as valid data, therefore:

N≦(Original Depth Array) (6)

will generate a series of regression sets based on what data was supplied and where it has been marked as valid. In the simple case of a gamma-ray, resistivity and neutron may be used as inputs used to solve for density. The present example implementation will cycle through the depths in the input array, at each index j.

At each depth in a set of well log measurements, the program will compute logic flags to determine whether or not to use the data in the regression at that depth. The criterion is based on whether or not the input curves (Cj,k,i) have been flagged as invalid or erroneous.

In the present example, if at the current depth it has been determined that gamma-ray, resistivity and neutron are acceptable to use (as a reminder to the user, in the present example, gamma-ray and resistivity are only invalid where they are null as there is no bad hole flag supplied for these curves), then these data will be input into the regression matrix as a row at index j.

After the matrix is fully constructed, it is solved and a set of weight coefficients (W_{0,i} . . . W_{N,i}) may be stored in an array. The weight coefficients may then then be used to reconstruct the value for density using Eq. 5 if the particular regression set (i with M=4, and input curves=unity, gamma-ray, resistivity, neutron) is the highest level solution available from the program during repair (i.e. the largest M available).

Table 2 shows an example of edited measurement outputs that may be used in various formats (graphic, data table) using an example method according to the present disclosure.

TABLE 2

| Output | | |
|---|---|---|
| Measurement | Description | Units |
| rhob_mlr | bulk density multi-linear regression | kg/m³ |
| | | g/cm³ |
| nphil_mlr | neutron porosity multi-linear | decimal |
| | regression | |
| dtc_mlr | compressional sonic multi-linear | μs/ft |
| | regression | |
| pe_mlr | photoelectric index multi-linear | barns/e |
| | regression | |
| rhob_edit | final edited bulk density curve | kg/m³ |
| | | g/cm³ |
| nphil_edit | final edited neutron porosity curve | decimal fraction |
| dtc_edit | final edited compressional sonic | μs/ft |
| | curve | |
| pe_edit | final edited photoelectric index curve | barns/e |
| xpd | final computed density patch/bad | dimensionless |
| | hole flag | |
| xpn | final computed neutron patch/bad | dimensionless |
| | hole flag | |
| xps | final computed sonic patch/bad hole | dimensionless |
| | flag | |
| xpp | final computed photoelectric index | dimensionless |
| | patch/bad hole flag | |

The present example implementation may cycle through the entire depth interval logged, or any subset thereof, using the largest matrix (largest M and implied best solution) available to it at any given time. As an example, if at a particular point density has been flagged as bad but all other curves have not, the program will utilize the coefficients from the gamma-ray, resistivity, neutron, sonic, photoelectric regression to reconstruct density. On the other hand, if all input flags indicate bad hole for all curves, the gamma-ray and resistivity regression coefficients may be used to calculate density. This is the default case in the event all input curves have been flagged as invalid data at a particular depth (j) in the borehole and illustrates why the quality of these data is important to generate the best possible reconstruction.

The present example method will smooth curves based on which smoothing input logic flags are selected and what size averaging window is supplied. The program will average the data with a sliding window and then patch the averaged data into the corresponding output data set as required. It is important that the user understand that the present example method corrects curves sequentially and then uses the “repaired” curves to generate subsequent regression sets. As a side effect, if smoothing is activated on the first curve, its effect will cascade throughout the other curves. Due to this behavior, it is not recommended that all smooth boxes are checked, only use those which are absolutely necessary to make the data appear as the user envisages that it should.

In one example, the process may use preselected well log data, for example, then Neutron/Density, Sonic/Density and Sonic/Neutron XpFlags may be convolved with each other to decompose the 2D spaces. As an example, if the density is flagged in both the Neutron/Density cross plot and Density/Sonic cross plot it is assumed to be invalid density data. On the other hand, if only selected in one cross plot it is then assumed to be valid. If the Cony. Xp checkbox is unchecked, the XpFlags are taken as literal inputs and no convolution takes places.

After the flags have been generated the program can be ran for the first time to see where the data has been flagged via cross-plotting. Flags can be modified by stretching or changing the shape of cross plot polygons (again, it is recommend they are kept open for the user to manipulate until editing is complete) and re-running the program. The flags can also be modified manually with user formulae. The user can modify the flag to be null where desired to indicate erroneous or poor quality data and unity everywhere else. It is worthy to note that the user should not modify the computed output flags (i.e., XpD, XpN, . . . ) as they are not inputs to the program and no change will occur, only input bad data flags should be modified.

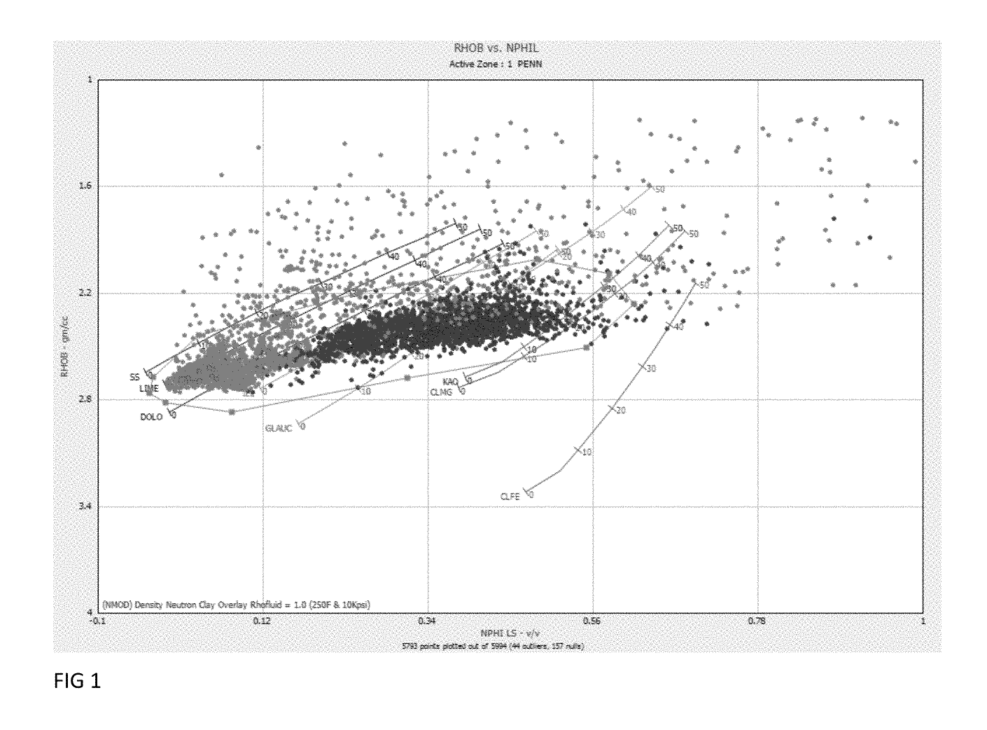

An example workflow according to the present disclosure is to first make any corrections to gamma-ray and resistivity as required, e.g., for wellbore diameter, position of the instruments in the wellbore and wellbore fluid properties. After these corrections have been made, a “bad hole flag” may be generated for the other log data input to indicate invalid data. The format in which the present example generated bad hole flags is such that the flag is set equal to null (e.g., −999) wherever the data is invalid and unity everywhere it is valid. This is the default output from an XpFlag curve generated through a cross plot of two different types of well log data. An example is shown in FIG. 1 where valid data is bounded by a polygon. Values outside the polygon may be flagged as “bad” and thus not directly entered into calculation of the regression matrix as input.

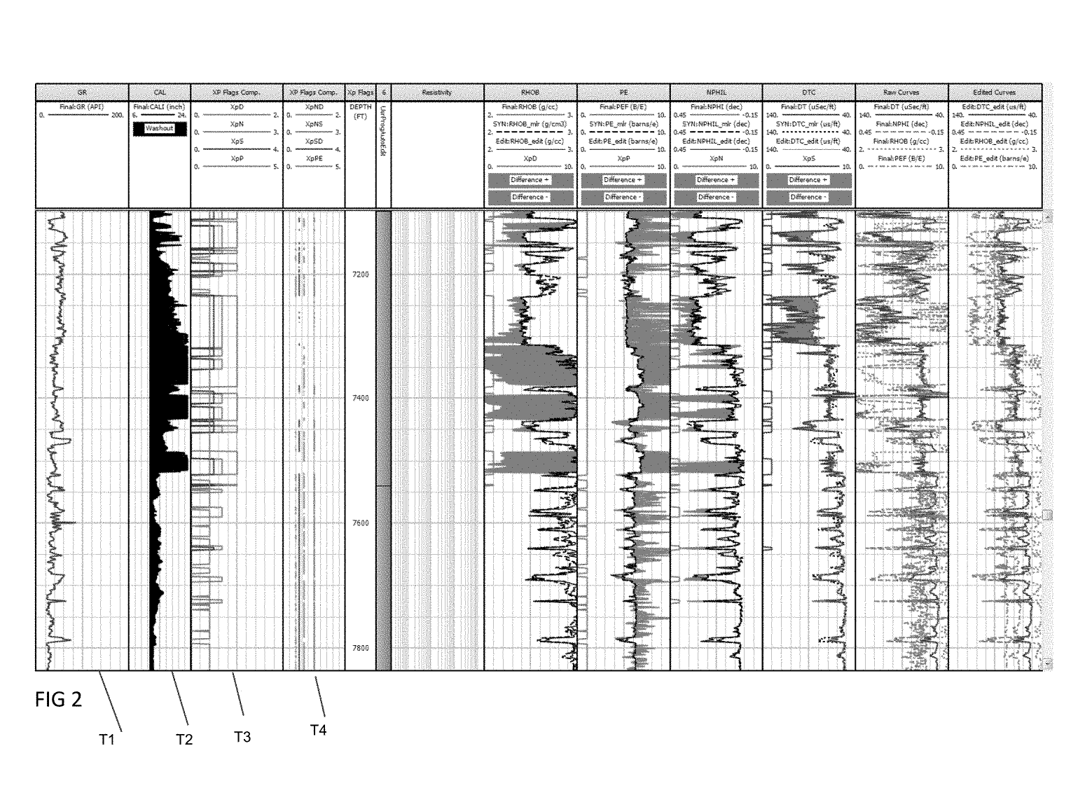

FIG. 2 shows an example zone where neutron and density flags have been computed from bad hole flags entered into the program. The straight lines with gaps (track 4—T4) are the bad hole flags, the square waves (track 3—T3) are the computed and averaged patch sections based on the provided bad hole flags. They are also shown again on the left side of the individual curve tracks alongside the data as a visual aid. Gamma ray well log data are shown in track 1 T1 and wellbore caliper (internal diameter) measurements are shown in track 2 T2 in FIG. 2.

If the user were to increase the fixed window parameter value, graphically the square wave pulse widths would increase in size and join when they began to overlap. Conversely, if the parameter were decreased in size the pulse widths would shrink. Empirically, the value of 5 feet for this parameter seems to work the best in practice eliminating the possibility of haphazard splices and resulting bizarre behavior in data. The user is reminded that where these computed bad hole flags, or square wave curves exist, regression data will be spliced into the edit curve.

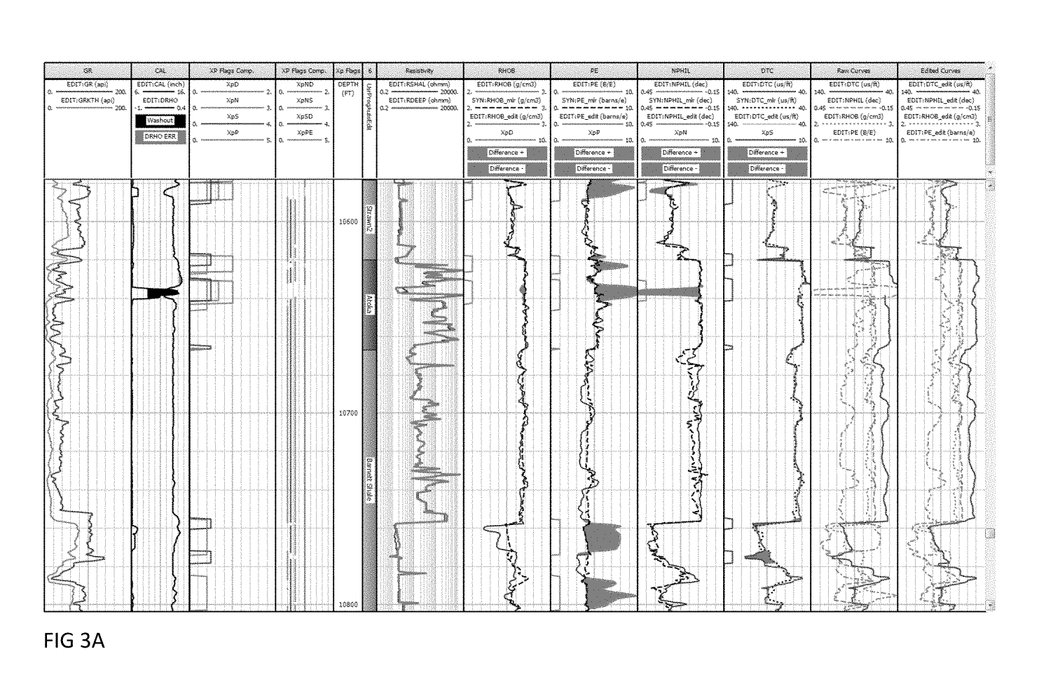

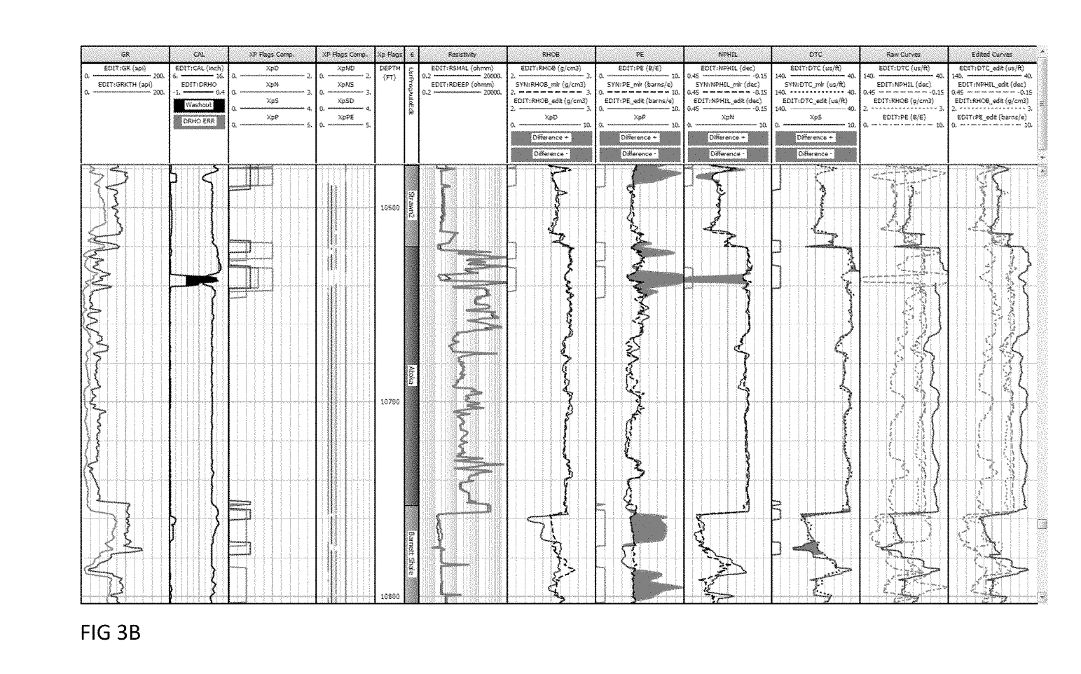

In some examples, zoning of a well log into axial segments (segments traversing a selected length along the longitudinal axis of the wellbore) may be used to further refine the results obtained using the example method. Zones may be, for example, constructed around similar lithology (rock mineral composition). In such examples, each axial zone will have its own regression sets built on whatever data is flagged as valid. When the user finds it difficult to reconstruct bad data over certain areas, zoning may be used to help determine a more accurate result by separating axial intervals having, e.g., different lithologies. A comparison of unzoned and zoned results as shown, respectively in FIGS. 3A and 3B.

Although the inputs in the present example are listed by default as gamma-ray, deep resistivity, bulk density, neutron porosity, delta-t compressional and photoelectric index, any well log measurements may be input to the program. The user may be made aware that the present example program makes several assumptions about the input data. For example, curves that are used as substitutes for gamma-ray and deep resistivity are assumed to be entirely valid data and are not edited or solved for, nor can a bad hole flag be provided for them. In addition, the relationship between resistivity and the other curves is a log/linear relationship and any input curve substituted for resistivity will have a logarithmic base 10 transform applied to it.

All other well log input measurements may be processed in the order which they are listed, sequentially. It is recommended that for a systematic workflow the default curves as listed (bulk density, neutron porosity, acoustic interval transit time or slowness, photoelectric effect index) are processed first, then a second pass of the program may be performed where additional log measurements that need to be edited are input, such as shear wave velocity. In addition it is important that the Conv. Xp logic is turned off unless the bad hole flags provided are able to be convolved together as originally intended.

As an example, if the example program was run initially with a selected set of “default” well log measurement and on a second pass it was the intention to edit shear sonic, the following would be recommended: the user inputs the selected measurements curves into the program; all bad hole flag curves would be left blank (or one measurement type could be used as well) with the exception of the bad hole flag used to delineate invalid shear sonic data.

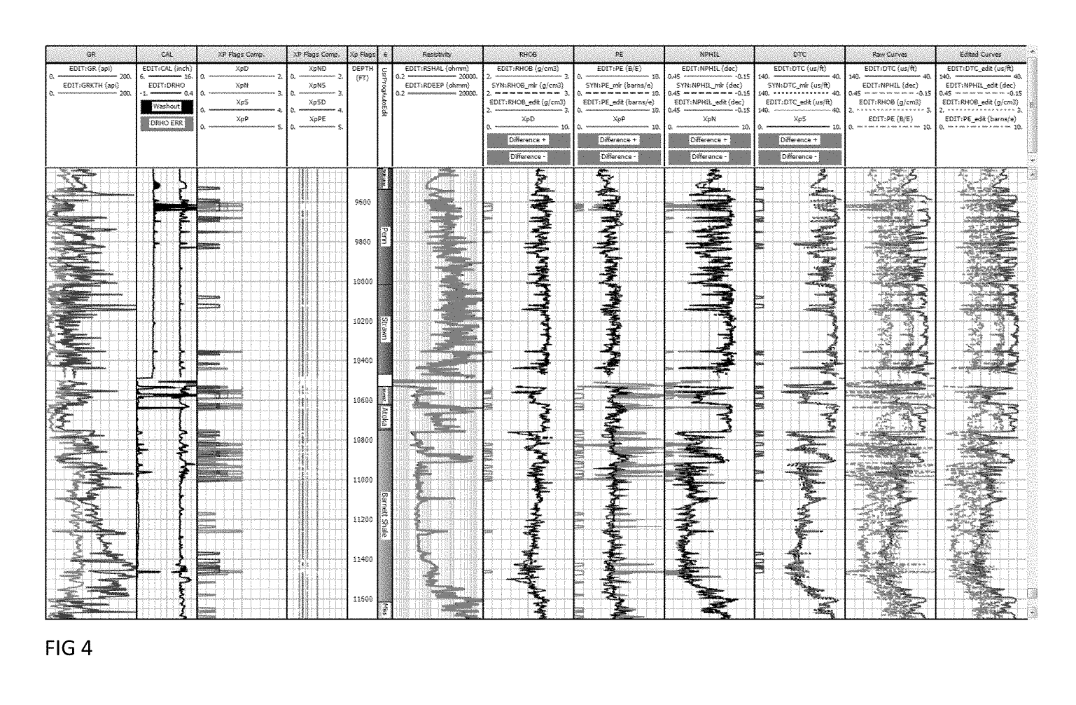

Once the user is satisfied with the results, the reconstructed curves may be used for any further computations or otherwise. These curves are shown alongside the input curves in the furthermost right track of an example program presentation supplied, as shown in FIG. 4.

FIG. 5 depicts an example computing system 100 in accordance with some embodiments. The computing system 100 may be an individual computer system 101A or an arrangement of distributed computer systems. The computer system 101A may include one or more analysis modules 102 that may be configured to perform various tasks according to some embodiments, such as the tasks depicted in FIGS.1-4. To perform these various tasks, analysis module 102 may execute independently, or in coordination with, one or more processors 104, which may be connected to one or more storage media 106. The processor(s) 104 may also be connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be on a ship underway on the ocean or on a well drilling location, while in communication with one or more computer systems such as 101C and/or 101D that may be located in one or more data centers on shore, aboard ships, and/or located in varying countries on different continents).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. the storage media 106 are depicted as within computer system 101A, in some embodiments, the storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above may be provided on one computer-readable or machine-readable storage medium, or alternatively, can be provided on multiple computer-readable or machine-readable storage media distributed in a large system having possibly plural nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that computing system 100 may have more or fewer components than shown, may combine additional components not depicted in the example embodiment of FIG. 5, and/or computing system 100 may have a different configuration or arrangement of the components depicted in FIG. 5. The various components shown in FIG. may be implemented in hardware, software, or a combination of both hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for estimating values of well log measurements of a first selected type in wellbore sections wherein the measurements of the selected type are determined not to be valid, comprising:
in a computer, establishing a linear relationship between well log measurements of a first selected type and well log measurements of a second selected type, the well log measurements of the second selected type being substantially valid over an entire measured axial section of the wellbore, the well log measurements of the first and second types obtained by moving a well logging instrument along the interior of a wellbore; and
in the computer, estimating correct values of the well log measurements of the first type in the wellbore sections using measured values of the well log measurements of the second type and the linear relationship.

2. The method of claim 1 further comprising establishing in the computer a respective linear relationship between each of a plurality of types of well log measurements and the well log measurements of the first selected type, and estimating correct values of the well log measurements of the first type in the wellbore sections using measured values of the plurality of measurement types and each respective linear relationship.

3. The method of claim 1 wherein the well log measurements of the second type comprise at least one of gamma ray and resistivity.

4. The method of claim 1 wherein the well log measurements of the first type comprise bulk density.

5. The method of claim 1 wherein the wellbore sections are determined by in the computer cross plotting values of well log measurements of the first type with values of well log measurements of a different type than the first type

6. The method of claim 5 wherein the well log measurements of the different type comprise well log measurements of the second type.

7. The method of claim 1 further comprising separating the well log measurements of the first type and the second type into a plurality of axial segments.

8. The method of claim 7 wherein each axial segment corresponds to a selected formation lithology.
